(19) United States
(12) Patent Application Publication
(10) Pub. No.: US 2026/0236971 A1
(43) Pub. Date: Aug. 13, 2026

(54) AUTOMATED SEARCH, CATEGORIZATION, AND VALUATION OF ITEMS EXTRACTED FROM VIDEO OR IMAGE

(71) Applicant: Novatrak Inc., Boise, ID (US)

(72) Inventors: Faisal Shah, Boise, ID (US); Christopher Johnson, Eagle, ID (US)

(73) Assignee: Novatrak Inc., Boise, ID (US)

(21) Appl. No.: 19/178,219

(22) Filed: Apr. 14, 2025

Related U.S. Application Data
(60) Provisional application No. 63/757,641, filed on Feb. 12, 2025.

(51) Int. Cl. G06Q 30/0601; G10L 15/26

(52) U.S. Cl. CPC G06Q 30/0625; G10L 15/26

(57) ABSTRACT

Novel tools and techniques are provided for implementing automated search, categorization, and valuation of items extracted from video or image. In examples, a computing system may autonomously identify an object from an area in an image, using image recognition, and may autonomously query one or more databases and/or one or more search engines for objects equivalent to the identified object and corresponding prices. The computing system may receive results from the one or more databases and/or the one or more search engines, the results including an equivalent object(s) and a price(s) associated with each equivalent object. The computing system may autonomously perform a valuation of the identified object, based on the price(s) associated with each equivalent object, may autonomously generate a report based on the valuation, and may present the report to a user or user device.

### CROSS-REFERENCES TO RELATED APPLICATIONS

This application claims priority to U.S. Patent Application Ser. No. 63/757,641 (the " '641 Application"), filed February 12, 2025, by Faisal Shah (attorney docket no. 269566US00), entitled, "Automated Search, Categorization, and Valuation of Items Extracted from Video or Image," the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing automated search, categorization, and valuation of items extracted from video or image.

### BACKGROUND

When evaluating a value of items in a space (e.g., a room(s) of a home, a store house, etc.), conventional techniques require either manually compiling sales prices from payment receipts of the items or manually entering search queries in search engines and databases then manually identifying which items (and their corresponding prices) are equivalent to the items being evaluated. A lack of a consolidated computing system that identifies, categorizes, and then performs valuation of such items results in inefficient and inconsistent valuations of items. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing automated search, categorization, and valuation of items extracted from video or image, in accordance with various embodiments.

FIGS. 2A-2F depicts flow diagrams illustrating an example method for implementing automated search, categorization, and valuation of items extracted from video or image, in accordance with various embodiments.

FIGS. 3A-3C depicts flow diagrams illustrating another example method for implementing automated search, categorization, and valuation of items extracted from video or image, in accordance with various embodiments.

FIG. 4 depicts a block diagram illustrating an exemplary computer or system hardware architecture, in accordance with various embodiments.

### DETAILED DESCRIPTION OF CERTAIN EMBODIMENTS

### Overview

As briefly described above, valuation of items (or objects) is important or at least useful for insurance claims (such as for insuring against natural disasters such as fires, floods, tornadoes, hurricanes, landslides, earthquakes, etc., or against manmade disasters such as conflicts, accidents, etc.), for estate valuations, for sales, for auctions, for inventory-keeping, etc. However, when evaluating a value of items in a space (e.g., a room(s) of a home, a store house, etc.), conventional techniques require either manually compiling sales prices from payment receipts of the items or manually entering search queries in search engines and databases then manually identifying which items (and their corresponding prices) are equivalent to the items being evaluated. A lack of a consolidated computing system that identifies, categorizes, and then performs valuation of such items results in inefficient and inconsistent valuations of items.

The present technology provides for automated search, categorization, and valuation of items extracted from video or image. In examples, a computing system may receive a first image of a first area, may autonomously identify a first object from the first area in the first image, using image recognition, and may autonomously query at least one of one or more databases or one or more search engines for one or more objects that are equivalent to the first object and corresponding prices. The computing system may receive a set of results from the at least one of the one or more databases or the one or more search engines, the set of results including at least one equivalent object and at least one price associated with each equivalent object. The computing system may autonomously perform a valuation of the first object, based on the at least one price associated with each of the at least one equivalent object that is included in the set of results, may autonomously generate a report based on the valuation, and may present the report to a user or user device. In this manner, with the system as described herein, efficient and consistent valuations of items or objects may be achieved.

These and other aspects of the systems and methods for implementing automated search, categorization, and valuation of items extracted from video or image are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes "a" through "n" may be used, where n denotes any suitable non-negative integer number (unless it denotes the number 14, if there are components with reference numerals having suffixes "a" through "m" preceding the component with the reference numeral having a suffix "n"), and may be either the same or different from the suffix "n" for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term "about." In this application, the use of the singular includes the plural unless specifically stated otherwise, and use of the terms "and" and "or" means "and/or" unless otherwise indicated. Moreover, the use of the term "including," as well as other forms, such as "includes" and "included," should be considered non-exclusive. Also, terms such as "element" or "component" encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase "at least one of element A, element B, or element C" (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system, a first image of a first area; autonomously identifying, by the computing system, a first object from the first area in the first image, using image recognition; autonomously querying, by the computing system, at least one of one or more databases or one or more search engines for one or more objects that are equivalent to the first object and corresponding prices; receiving, by the computing system, a set of results from the at least one of the one or more databases or the one or more search engines, the set of results including at least one equivalent object and at least one price associated with each equivalent object; autonomously performing, by the computing system, a valuation of the first object, based on the at least one price associated with each of the at least one equivalent object that is included in the set of results; autonomously generating, by the computing system, a report based on the valuation; and presenting, by the computing system, the report to a user.

In another aspect, the technology relates to a system, including a processing system and memory coupled to the processing system. The memory may include computer executable instructions that, when executed by the processing system, may cause the system to perform operations including: receiving a first image of a first area; autonomously identifying a first object from the first area in the first image, using image recognition; autonomously querying at least one of one or more databases or one or more search engines for one or more objects that are equivalent to the first object and corresponding prices; receiving a set of results from the at least one of the one or more databases or the one or more search engines, the set of results including at least one equivalent object and at least one price associated with each equivalent object; autonomously performing a valuation of the first object, based on the at least one price associated with each of the at least one equivalent object that is included in the set of results; autonomously generating a report based on the valuation; and presenting the report to a user.

In yet another aspect, the technology relates to a method, including capturing, by a computing system and using a camera, one of a first image or a first video of a first area; autonomously identifying, by the computing system, a first object from the first area in the one of the first image or the first video, using image recognition; autonomously querying, by the computing system, at least one of one or more databases or one or more search engines for one or more objects that are equivalent to the first object and corresponding prices; receiving, by the computing system, a set of results from the at least one of the one or more databases or the one or more search engines, the set of results including at least one equivalent object and at least one price associated with each equivalent object; autonomously performing, by the computing system, a valuation of the first object, based on the at least one price associated with each of the at least one equivalent object that is included in the set of results; autonomously generating, by the computing system, a valuation output based on the valuation; and presenting, by the computing system, the valuation output on a display device.

In still another aspect, the technology relates to a method, including capturing, by a computing system and using a camera, one of a first image or a first video of a first area; autonomously identifying, by the computing system, a first object from the first area in the one of the first image or the first video, using image recognition; autonomously querying, by the computing system, at least one of one or more databases or one or more search engines for one or more objects that are equivalent to the first object and corresponding prices; receiving, by the computing system, a set of results from the at least one of the one or more databases or the one or more search engines, the set of results including at least one equivalent object and at least one price associated with each equivalent object; autonomously performing, by the computing system, a valuation of the first object, based on the at least one price associated with each of the at least one equivalent object that is included in the set of results; autonomously generating, by the computing system, a valuation output based on the valuation; and presenting, by the computing system, the valuation output on a display device.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

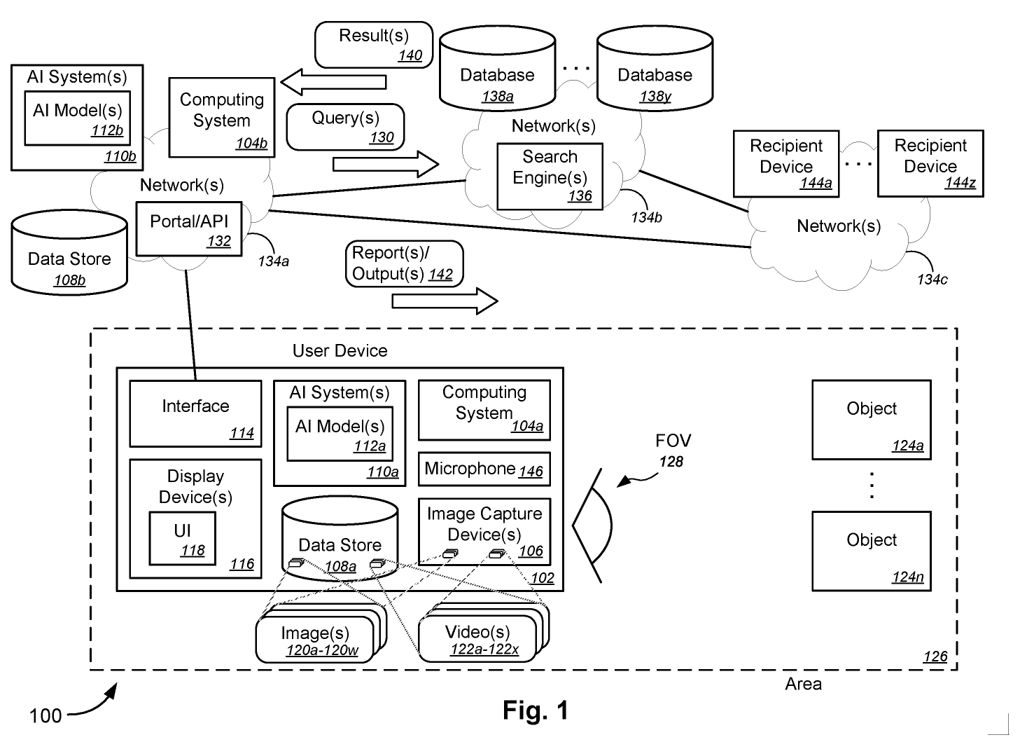

Turning to the embodiments as illustrated by the drawings, FIGS. 1-4 illustrate some of the features of methods, systems, and apparatuses for implementing automated search, categorization, and valuation of items extracted from video or image, as referred to above. The methods, systems, and apparatuses illustrated by FIGS. 1-4 refer to examples of different embodiments that include various components and steps, which can be considered alternatives or which can be used in conjunction with one another in the various embodiments. The description of the illustrated methods, systems, and apparatuses shown in FIGS. 1-4 is provided for purposes of illustration and should not be considered to limit the scope of the different embodiments.

With reference to the figures, FIG. 1 depicts an example system 100 for implementing automated search, categorization, and valuation of items extracted from video or image, in accordance with various embodiments.

In the non-limiting embodiment of FIG. 1, system 100 may include a user device 102, which may include a computing system 104a, an image capture device(s) 106, and a data store 108a. In some examples, the user device 102 may further include an artificial intelligence ("AI") system(s) 110a that trains and uses AI model(s) 112a. In some cases, the user device 102 may further include an interface 114 and a display device(s) 116. In some instances, a user interface ("UI") 118 may be presented on the display device(s) 116. In examples, a plurality of images 120a-120w (collectively, "images 120" or the like) and/or a plurality of videos 122a-122x (collectively, "videos 122" or the like) may be images and/or videos of one or more objects among a plurality of objects 124a-124n (collectively, "objects 124" or the like) that are located within area 126 and that are captured by the image capture device(s) 106 within its field of view ("FOV") 128. In some cases, the plurality of images 120a-120w and/or the plurality of videos 122a-122x may be stored in the data store 108a. In some examples, system 100 may further include one or more of computing system 104b, an AI system(s) 110b that trains and uses AI model(s) 112b, and/or data store 108b, each within network(s) 134a and communicatively coupled with the user device 102 via interface 114 and/or portal or application programming interface ("API") 132.

In an example, the image capture device(s) 106 may capture a first image 120a or a first video 122a of a first object 124a that is located within area 126 (e.g., a room, an office, a suite, a hall, a shop, a vehicle, a garage, a storage facility, a warehouse, a museum, a marketplace, or an auction house, and/or the like) that is within the FOV 128 of the image capture device(s) 106. In some cases, the computing system 104a may store the first image 120a or the first video 122a in data store 108a of the user device 102. In some instances, the first image 120a or the first video 122a in data store 108a may be alternatively or additionally stored in a network or cloud-based data store (e.g., data store 108b, or the like). In examples, the computing system 104a and/or 104b (collectively, "computing system 104" or the like) may receive the first image 120a, either from the image capture device(s) 106 in user device 102, the data store 108a in user device 102, or the data store 108b in network(s) 134a. The computing system 104 may autonomously identify the first object 124a from the area 126 in the first image 120a or the first video 122a, using image recognition. In some cases, the computing system 104 may categorize the first object 124a into a first item category of a plurality of item categories, which may include two or more of furniture, flooring, lighting fixtures, plumbing fixtures, building parts, electronic device, media content storage device, media content media, office appliances, kitchenware, books, art pieces, sporting equipment, workout equipment, fashion, fashion accessories, bedding, tools, vehicles, or vehicle components and accessories, and/or the like. In some instances, the first object 124a may include one of an article of furniture, a flooring finish, a lighting fixture, a plumbing fixture, a window, a door, a consumer electronic device, an optical data storage device, optical data storage media, a magnetic data storage device, magnetic data storage media, a phonograph, a phonograph record, an office appliance, a kitchen appliance, a kitchen tool, a utensil, dishes, cookware, dinnerware, pottery, a book, a poster, a painting, a drawing, a sculpture, a statue, an ornament, sports equipment, workout equipment, clothing, footwear, jewelry, a timepiece, a fashion accessory, a piece of luggage, bedding, a firearm, a blade, a tool, a vehicle, a vehicle feature, or a vehicle accessory, and/or the like.

The computing system 104 may autonomously query at least one of one or more databases 138 among a plurality of databases 138a-138yand/or search engine(s) 136 for one or more objects that are equivalent to the first object 124a and corresponding prices, using a query(s) 130 that is either generated by the computing system 104 or outputted by a language model ("LM"; e.g., an AI model(s) 112b) in response to a prompt that is generated and sent by the computing system 104 to the LM. In some examples, autonomously querying the at least one of the one or more databases 138 or the search engine(s) 136 for the one or more objects that are equivalent to the first object 124a and corresponding prices may be performed via one or more of the UI 118, the portal 132, or the API 132 via networks 134a and 134b, and may be based on the identified first object and the first item category. The computing system 104 may receive one or more results 140 from the at least one of the one or more databases 138 and/or search engine(s) 136, the one or more results 140 may include at least one equivalent object and at least one price associated with each equivalent object. The computing system 104 may autonomously perform a valuation of the first object 124a, based on the at least one price associated with each of the at least one equivalent object that is included in the one or more results 140. The computing system 104 may autonomously generate a report(s) or valuation output(s) 142, based on the valuation of the first object 124a. The computing system 104 may present the report(s) or valuation output(s) 142 to one or more recipient devices 144 among a plurality of 144a-144z in network(s) 134c, the one or more recipient devices 144 being associated with corresponding one or more users. Herein, n, w, x, y, and z are non-negative integer numbers that may be either all the same as each other, all different from each other, or some combination of same and different (e.g., one set of two or more having the same values with the others having different values, a plurality of sets of two or more having the same value with the others having different values, etc.). In some examples, the user device 102 and/or the one or more recipient devices 144 may each include or further include a microphone(s) 146 that is used to capture audio input (e.g., voice input from the one or more users, and/or the like).

According to some embodiments, unless otherwise indicated, networks 134a-134c may each include, without limitation, one of a local area network ("LAN"), including, without limitation, a fiber network, an Ethernet network, a Token-Ring™ network, and/or the like; a wide-area network ("WAN"); a wireless wide area network ("WWAN"); a virtual network, such as a virtual private network ("VPN"); the Internet; an intranet; an extranet; a public switched telephone network ("PSTN"); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 134a-134c may include an access network of the service provider (e.g., an Internet service provider ("ISP")). In another embodiment, the networks 134a-134c may include a core network of the service provider and/or the Internet.

In some instances, the user device 102 may include, but is not limited to, one of a desktop computer, a laptop computer, a tablet computer, a smart phone, or a mobile phone, and/or the like. In some cases, the plurality of recipient devices 144a-144z may each include, without limitation, one of a desktop computer, a laptop computer, a tablet computer, a smart phone, a mobile phone, a server computer, or a cloud computing system, and/or the like. In examples, the users associated with the plurality of recipient devices 144a-144z may each include, without limitation, one of an owner of the first object 124a, an owner of one or more objects among the plurality of objects 124a-124n, an insurer or insurance company insuring one or more objects among the plurality of objects 124a-124n, an appraiser or appraisal company appraising one or more objects among the plurality of objects 124a-124n, a sales person or business placing one or more objects among the plurality of objects 124a-124n on sale, an auctioneer or auction house putting one or more objects among the plurality of objects 124a-124n on auction, a buyer or company preparing bids for purchasing one or more objects among the plurality of objects 124a-124n that are on sale or on auction, an estate valuation preparer or estate valuation service provider evaluating values of one or more objects among the plurality of objects 124a-124n, an estimator of a moving company or the moving company estimating values of one or more objects among the plurality of objects 124a-124n in preparation for shipping the one or more objects among the plurality of objects 124a-124n, an accountant or accounting firm compiling an inventory and worth of assets among one or more objects among the plurality of objects 124a-124n, or a warehouse working or holding company compiling an inventory and worth of goods among one or more objects among the plurality of objects 124a-124n, and/or the like.

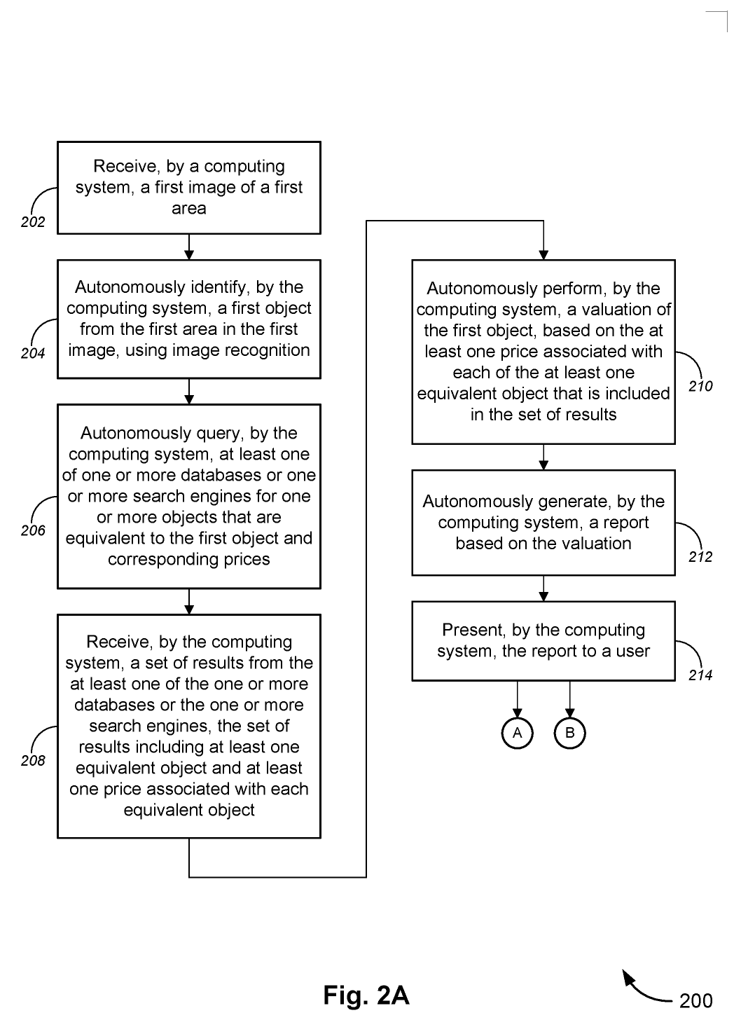

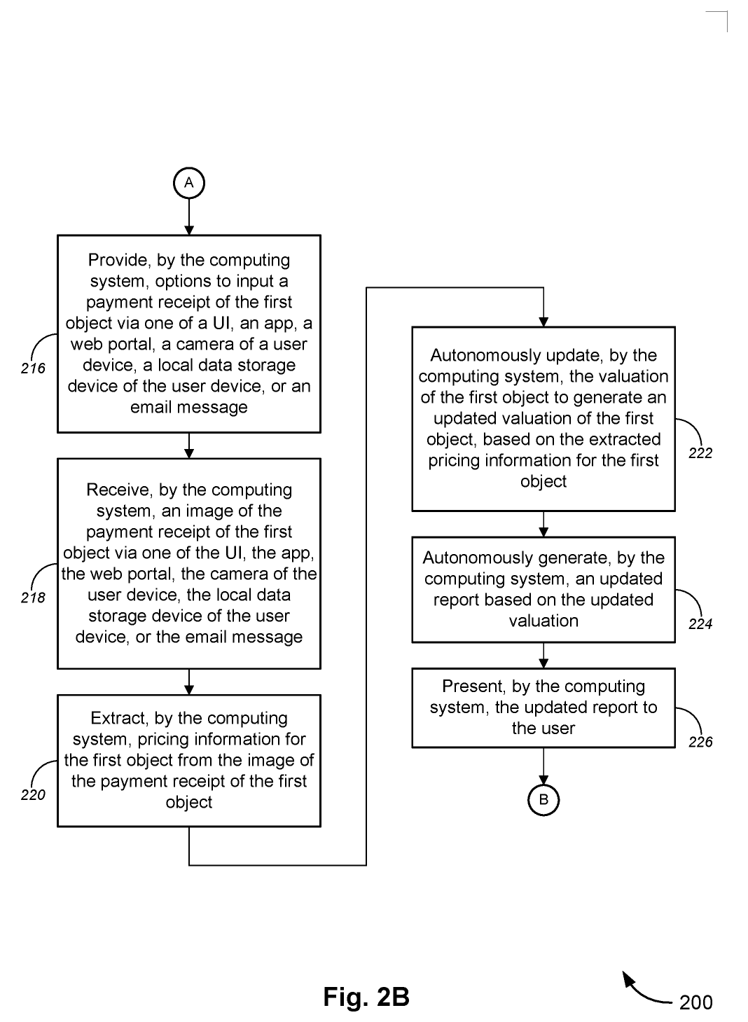

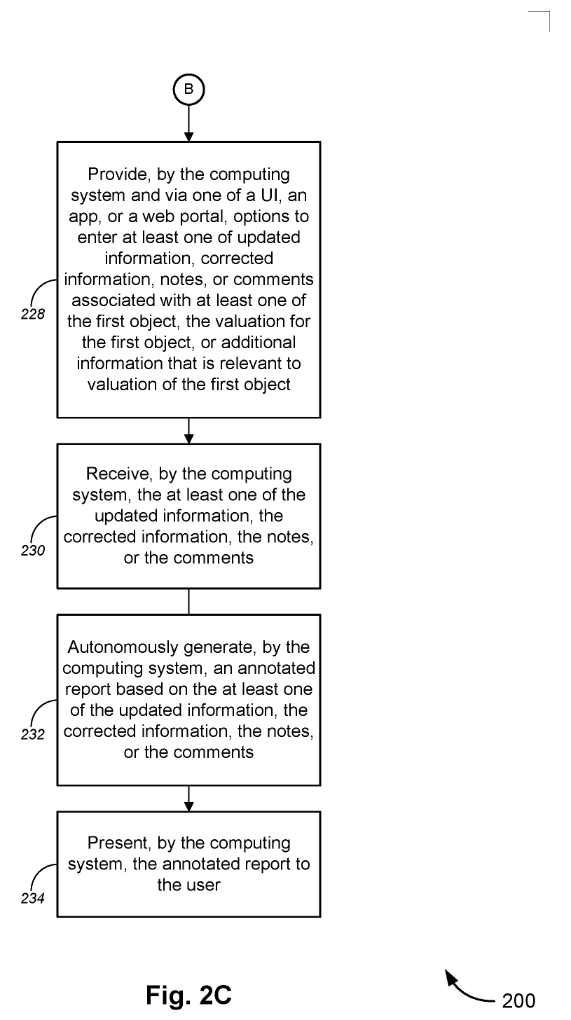

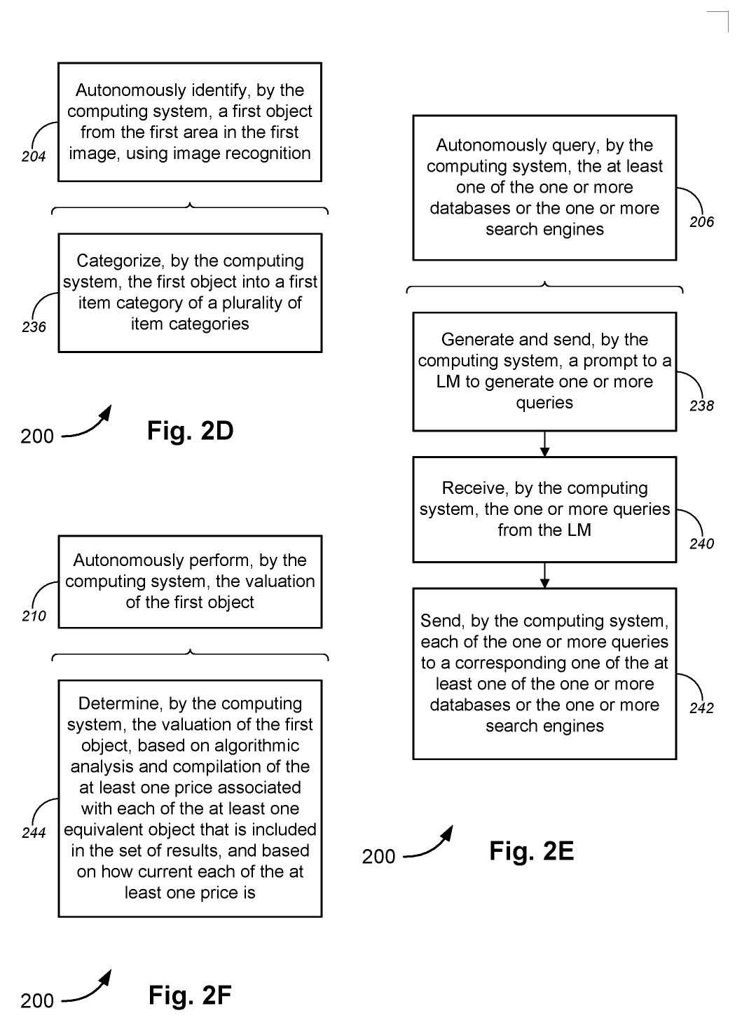

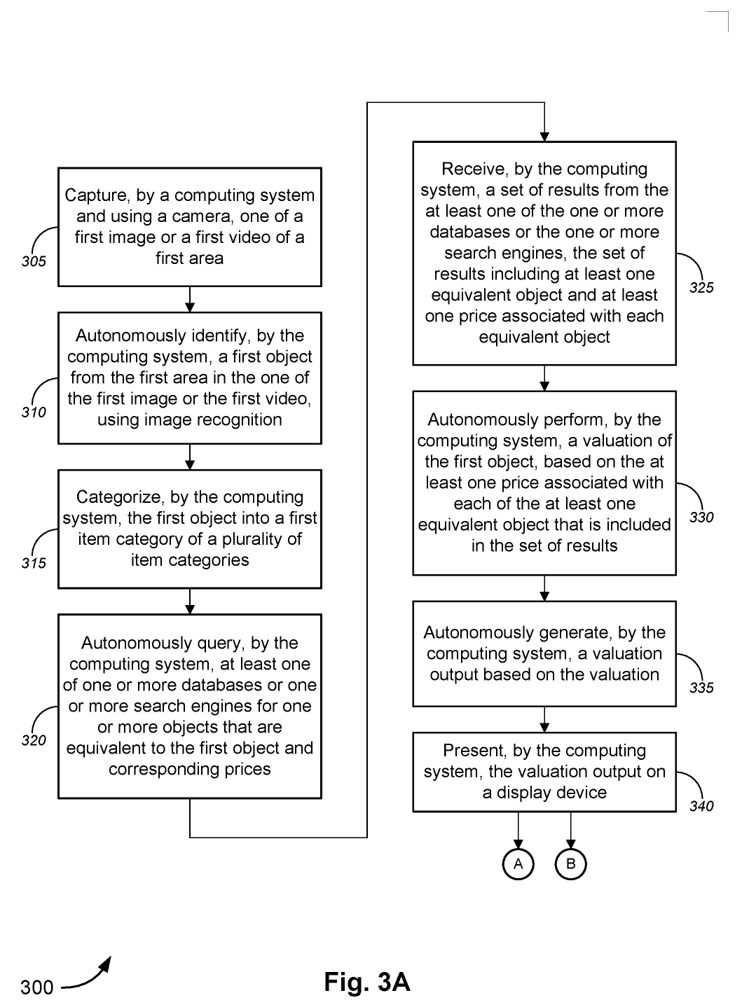

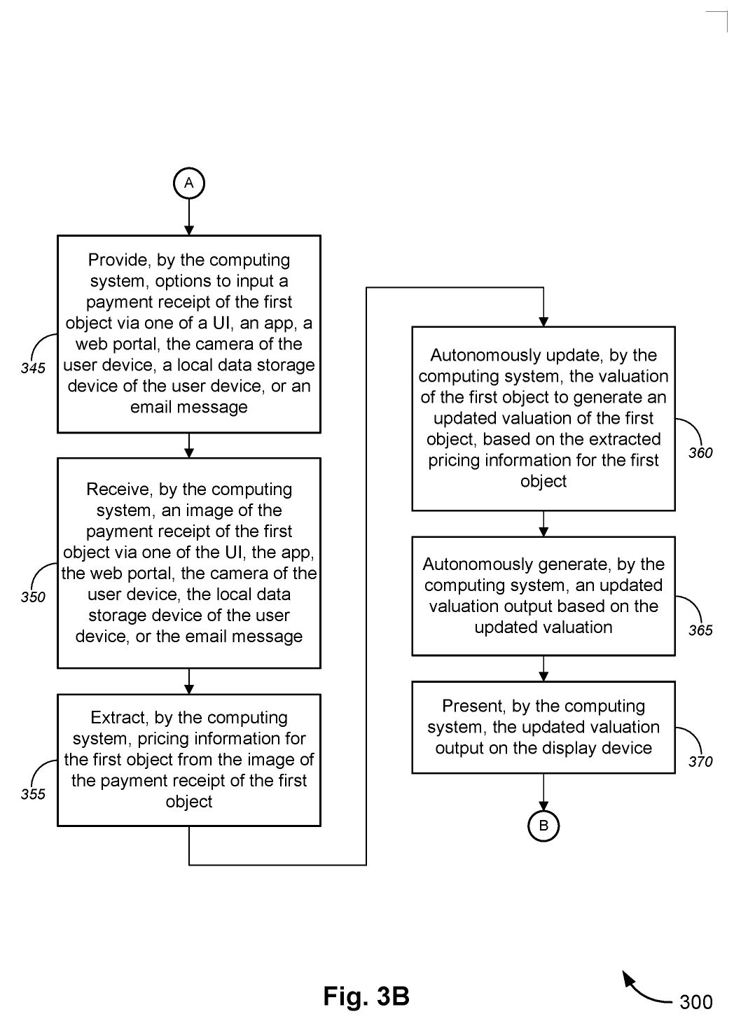

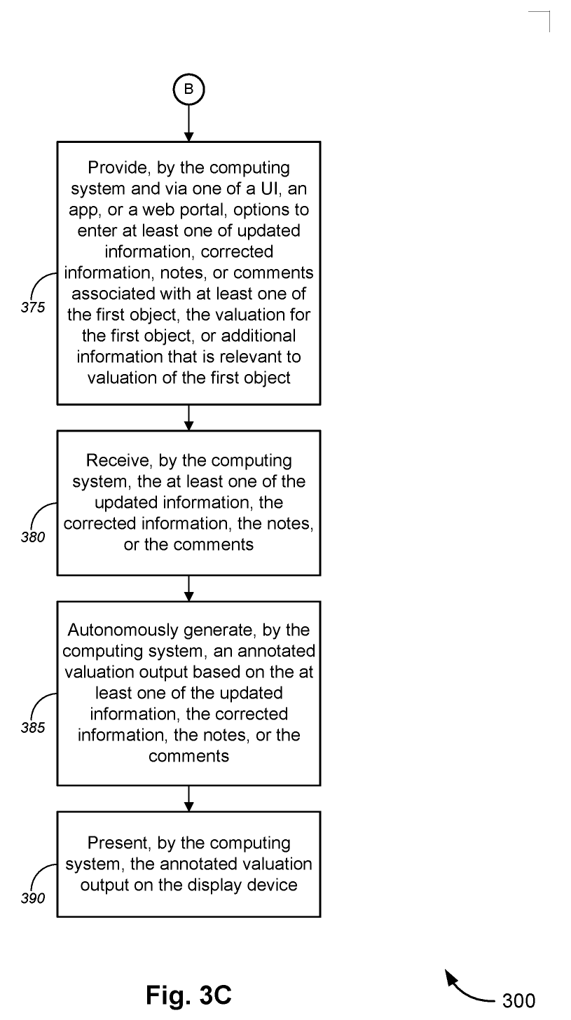

In operation, computing systems 104a and/or 104b may perform methods for implementing automated search, categorization, and valuation of items extracted from video or image, as described in detail with respect to FIGS. 2A-3D. For example, example methods 200 and 300 as described below with respect to FIGS. 2A-F and 3A-3C, respectively, may be applied with respect to the operations of system 100 of FIG. 1.

FIGS. 2A-2F (collectively, "FIG. 2") depicts flow diagrams illustrating an example method 200 for implementing automated search, categorization, and valuation of items extracted from video or image, in accordance with various embodiments. Referring to FIGS. 2A-2F, the operations of example method 200 may be performed by a computing system (e.g., computing system 104a or 104b of FIG. 1, or the like). Method 200 of FIG. 2A either may continue onto FIG. 2B following the circular marker denoted, "A," and/or may continue onto FIG. 2C following the circular marker denoted, "B." Method 200 of FIG. 2B may continue onto FIG. 2C following the circular marker denoted, "B."

In the example method 200 of FIG. 2A, at operation 202, a computing system may receive a first image (e.g., an image among the plurality of images 120a-120w of FIG. 1, or the like) of a first area (e.g., area 126 of FIG. 1, or the like). At operation 204, the computing system may autonomously identify a first object (e.g., an object among the plurality of objects 124a-124n of FIG. 1, or the like) from the first area in the first image, using image recognition. At operation 206, the computing system may autonomously query at least one of one or more databases (e.g., one or more among the plurality of databases 138a-138y of FIG. 1, or the like) or one or more search engines (e.g., the search engine(s) 136 of FIG. 1, or the like) for one or more objects that are equivalent to the first object and corresponding prices. At operation 208, the computing system may receive a set of results (e.g., result(s) 140 of FIG. 1, or the like) from the at least one of the one or more databases or the one or more search engines. In some cases, the set of results may include at least one equivalent object and at least one price associated with each equivalent object. At operation 210, the computing system may autonomously perform a valuation of the first object, based on the at least one price associated with each of the at least one equivalent object that is included in the set of results. At operation 212, the computing system may autonomously generate a report (e.g., report(s) or output(s) 142 of FIG. 1, or the like) based on the valuation. At operation 214, the computing system may present the report to a user.

In examples, the first area may include one of a room, an office, a suite, a hall, a shop, a vehicle, a garage, a storage facility, a warehouse, a museum, a marketplace, or an auction house, and/or the like. In some cases, the first object may include one of an article of furniture, a flooring finish, a lighting fixture, a plumbing fixture, a window, a door, a consumer electronic device, an optical data storage device, optical data storage media, a magnetic data storage device, magnetic data storage media, a phonograph, a phonograph record, an office appliance, a kitchen appliance, a kitchen tool, a utensil, dishes, cookware, dinnerware, pottery, a book, a poster, a painting, a drawing, a sculpture, a statue, an ornament, sports equipment, workout equipment, clothing, footwear, jewelry, a timepiece, a fashion accessory, a piece of luggage, bedding, a firearm, a blade, a tool, a vehicle, a vehicle feature, or a vehicle accessory, and/or the like.

In some examples, the report may include one of a spreadsheet, a summary document, an appraisal report, an insurance assessment report, a sales catalogue, an auction catalogue, an estate valuation report, or an inventory, and/or the like. In examples, presenting the report (at operation 214) may include the computing system presenting the report in at least one of a UI (e.g., UI 118 of FIG. 1, or the like), an app, a web portal (e.g., portal or API 132 of FIG. 1, or the like), or an email message.

At operation 216 in FIG. 2B (following the circular marker denoted, "A," in FIG. 2A), method 200 may include the computing system providing options to input a payment receipt of the first object via one of a UI, an app, a web portal, a camera of a user device, a local data storage device of the user device, or an email message, and/or the like. At operation 218, the computing system may receive an image of the payment receipt of the first object via one of the UI, the app, the web portal, the camera of the user device, the local data storage device of the user device, or the email message, and/or the like. At operation 220, the computing system may extract pricing information for the first object from the image of the payment receipt of the first object. At operation 222, the computing system may autonomously update the valuation of the first object to generate an updated valuation of the first object, based on the extracted pricing information for the first object. At operation 224, the computing system may autonomously generate an updated report based on the updated valuation. At operation 226, the computing system may present the updated report to the user. In examples, method 200 may continue onto the process at operation 228 in FIG. 2C following the circular marker denoted, "B."

At operation 228 in FIG. 2C (following the circular marker denoted, "B," in FIGS. 2A or 2B), method 200 may include the computing system providing, via one of a UI, an app, or a web portal, and/or the like, options to enter at least one of updated information, corrected information, notes, or comments, and/or the like, associated with at least one of the first object, the valuation for the first object, or additional information that is relevant to valuation of the first object. At operation 230, the computing system may receive the at least one of the updated information, the corrected information, the notes, or the comments. In some cases, the at least one of the updated information, the corrected information, the notes, or the comments is received via one of the UI, the app, or the web portal, and/or the like. At operation 232, the computing system may autonomously generate an annotated report based on the at least one of the updated information, the corrected information, the notes, or the comments, and/or the like. At operation 234, the computing system may present the annotated report to the user. In some examples, the options to enter the at least one of the updated information, the corrected information, the notes, or the comments may include options to enter the at least one of the updated information, the corrected information, the notes, or the comments using voice input via a microphone (e.g., microphone 146 of FIG. 1, or the like). In some cases, receiving the at least one of the updated information, the corrected information, the notes, or the comments may include: (a) receiving, by the computing system, a first voice input associated with the at least one of the updated information, the corrected information, the notes, or the comments; and (b) converting, by the computing system, the first voice input into a first textual input, using speech-to-text functionality. In some instances, the annotated report may be autonomously generated based on at least the first textual input converted from the first voice input.

In examples, the one of the first image or the first video may depict the first object and a plurality of other objects. In some examples, the computing system may provide, on the display device, options to select a second object among the plurality of other objects. In examples, the options to select the second object may include options to manually draw a boundary around the second object using one of a finger input or a stylus input, options to draw boundary shapes around the second object, or options to highlight the second object after being autonomously identified by the computing system, and/or the like. In some cases, the computing system may receive selection of the second object and selection of options to categorize and to perform an ecommerce search of the second object. In some instances, the computing system may categorize the second object into one or more other item categories among the plurality of item categories. The computing system may autonomously query the at least one of the one or more databases or the one or more search engines for a plurality of equivalent other objects that are equivalent to the second object and corresponding descriptions of the second object, further based on the one or more other item categories. The computing system may autonomously generate, using an AI model, AI-generated descriptions of the second object, and may autonomously query one or more ecommerce platforms for the second object based on at least one of the one or more other item categories or the AI-generated descriptions of the second object. The computing system may receive a second set of results from the one or more ecommerce platforms. In some examples, the second set of results may include at least one of the second object or one or more third objects equivalent to the second object. The computing system may present the second set of results to the user on the display device.

With reference to FIG. 2D, autonomously identifying the first object from the first image (at operation 204) may include the categorizing the first object into a first item category of a plurality of item categories (at operation 236). In some examples, the plurality of item categories may include two or more of furniture, flooring, lighting fixtures, plumbing fixtures, building parts, electronic device, media content storage device, media content media, office appliances, kitchenware, books, art pieces, sporting equipment, workout equipment, fashion, fashion accessories, bedding, tools, vehicles, or vehicle components and accessories, and/or the like. In such examples, autonomously querying the at least one of the one or more databases or the one or more search engines (at operation 206) may be based on the identified first object and the first item category.

Referring to FIG. 2E, autonomously querying the at least one of the one or more databases or the one or more search engines (at operation 206) may include the computing system generating and sending a prompt to an LM to generate one or more queries (e.g., one or more queries 130 of FIG. 1, or the like) (at operation 238); receiving the one or more queries from the LM (at operation 240); and sending each of the one or more queries to a corresponding one of the at least one of the one or more databases or the one or more search engines (at operation 242).

Turning to FIG. 2F, autonomously performing the valuation of the first object (at operation 210) may include the computing system determining the valuation of the first object, based on algorithmic analysis and compilation of the at least one price associated with each of the at least one equivalent object that is included in the set of results, and based on how current each of the at least one price is (at operation 244).

FIGS. 3A-3C (collectively, "FIG. 3") depicts flow diagrams illustrating another example method 300 for implementing automated search, categorization, and valuation of items extracted from video or image, in accordance with various embodiments. With reference to FIGS. 3A-3C, the operations of example method 300 may be performed by a computing system (e.g., computing system 104a or 104b of FIG. 1, or the like). Method 300 of FIG. 3A either may continue onto FIG. 3B following the circular marker denoted, "A," and/or may continue onto FIG. 3C following the circular marker denoted, "B." Method 300 of FIG. 3B may continue onto FIG. 3C following the circular marker denoted, "B."

In the example method 300 of FIG. 3, at operation 305, a computing system may capture, using a camera (e.g., image capture device(s) 106 of FIG. 1, or the like), one of a first image (e.g., an image among the plurality of images 120a-120w of FIG. 1, or the like) or a first video (e.g., a video among the plurality of videos 122a-122x of FIG. 1, or the like) of a first area (e.g., area 126 of FIG. 1, or the like). At operation 310, the computing system may autonomously identify a first object (e.g., an object among the plurality of objects 124a-124n of FIG. 1, or the like) from the first area in the one of the first image or the first video, using image recognition. At operation 315, the computing system may categorize the first object into a first item category of a plurality of item categories. In some examples, the plurality of item categories may include two or more of furniture, flooring, lighting fixtures, plumbing fixtures, building parts, electronic device, media content storage device, media content media, office appliances, kitchenware, books, art pieces, sporting equipment, workout equipment, fashion, fashion accessories, bedding, tools, vehicles, or vehicle components and accessories, and/or the like.

At operation 320, the computing system may autonomously query at least one of one or more databases (e.g., one or more among the plurality of databases 138a-138y of FIG. 1, or the like) or one or more search engines (e.g., the search engine(s) 136 of FIG. 1, or the like) for one or more objects that are equivalent to the first object and corresponding prices, in some cases, based on the identified first object (from operation 310) and the first item category (from operation 315). At operation 325, the computing system may receive a set of results (e.g., result(s) 140 of FIG. 1, or the like) from the at least one of the one or more databases or the one or more search engines. In some cases, the set of results may include at least one equivalent object and at least one price associated with each equivalent object. At operation 330, the computing system may autonomously perform a valuation of the first object, based on the at least one price associated with each of the at least one equivalent object that is included in the set of results. At operation 335, the computing system may autonomously generate a valuation output (e.g., report(s) or output(s) 142 of FIG. 1, or the like) based on the valuation. At operation 340, the computing system may present the valuation output to a display device (e.g., display device(s) 116 of FIG. 1, or the like).

In examples, the first area may include one of a room, an office, a suite, a hall, a shop, a vehicle, a garage, a storage facility, a warehouse, a museum, a marketplace, or an auction house, and/or the like. In some cases, the first object may include one of an article of furniture, a flooring finish, a lighting fixture, a plumbing fixture, a window, a door, a consumer electronic device, an optical data storage device, optical data storage media, a magnetic data storage device, magnetic data storage media, a phonograph, a phonograph record, an office appliance, a kitchen appliance, a kitchen tool, a utensil, dishes, cookware, dinnerware, pottery, a book, a poster, a painting, a drawing, a sculpture, a statue, an ornament, sports equipment, workout equipment, clothing, footwear, jewelry, a timepiece, a fashion accessory, a piece of luggage, bedding, a firearm, a blade, a tool, a vehicle, a vehicle feature, or a vehicle accessory, and/or the like.

In some examples, the valuation output may be presented on the display device as part of one of a spreadsheet, a summary document, an appraisal report, an insurance assessment report, a sales catalogue, an auction catalogue, an estate valuation report, or an inventory, and/or the like. In examples, presenting the valuation output (at operation 340) may include the computing system presenting the valuation output in at least one of a UI (e.g., UI 118 of FIG. 1, or the like), an app, a web portal (e.g., portal or API 132 of FIG. 1, or the like), or an email message.

In examples, method 300 either may continue onto the process at operation 345 in FIG. 3B following the circular marker denoted, "A," and/or may continue onto the process at operation 375 in FIG. 3C following the circular marker denoted, "B."

At operation 375 in FIG. 3C (following the circular marker denoted, "B," in FIGS. 3A or 3B), method 300 may include the computing system providing options to enter at least one of updated information, corrected information, notes, or comments, and/or the like, associated with at least one of the first object, the valuation for the first object, or additional information that is relevant to valuation of the first object via one of the UI, the app, or the web portal, and/or the like. At operation 380, the computing system may receive the at least one of the updated information, the corrected information, the notes, or the comments via one of the UI, the app, or the web portal, and/or the like. At operation 385, the computing system may autonomously generate an annotated valuation output based on the at least one of the updated information, the corrected information, the notes, or the comments, and/or the like. At operation 390, the computing system may present the annotated valuation output on the display device.

In some examples, the computing system may provide, on the display device, options to select one or more other objects among the plurality of other objects. In examples, the options to select the one or more other objects may include options to manually draw a boundary around the one or more other objects using one of a finger input or a stylus input, options to draw boundary shapes around the one or more other objects, or options to highlight the one or more other objects after being autonomously identified by the computing system, and/or the like. In some cases, the computing system may receive selection of the one or more other objects and selection of options to categorize and perform valuation of the selected one or more other objects. In some instances, the computing system may categorize the one or more other objects into one or more other item categories among the plurality of item categories. The computing system may autonomously query the at least one of the one or more databases or the one or more search engines for a plurality of equivalent other objects that are equivalent to the one or more other objects and a corresponding plurality of other prices, in some cases, further based on the one or more other item categories. The computing system may receive a second set of results from the at least one of the one or more databases or the one or more search engines. In some examples, the second set of results may include, for each of the one or more other objects, at least one equivalent other object and at least one other price associated with each equivalent other object. The computing system may autonomously perform a valuation of each of the one or more other objects, based on the at least one other price associated with each equivalent other object that is included in the second set of results. The computing system may autonomously generate a second valuation output based on the valuation of each of the one or more other objects, and may present the second valuation output on the display device.

Method 300 of FIGS. 3A-3C is otherwise similar, if not identical to method 200 of FIGS. 2A-2F, and the description of method 200 is applicable to method 300.

While the techniques and procedures in methods 200, 300 are depicted and/or described in a certain order for purposes of illustration, it should be appreciated that certain procedures may be reordered and/or omitted within the scope of various embodiments. Moreover, while the methods 200, 300 may be implemented by or with (and, in some cases, are described below with respect to) the system(s), example(s), or embodiment(s) 100 of FIG. 1 (or components thereof), such methods may also be implemented using any suitable hardware (or software) implementation. Similarly, while each of the system(s), example(s), or embodiment(s) 100 of FIG. 1 (or components thereof), can operate according to the methods 200, 300 (e.g., by executing instructions embodied on a computer readable medium), the system(s), example(s), or embodiment(s) 100 of FIG. 1 can each also operate according to other modes of operation and/or perform other suitable procedures.

### Exemplary System and Hardware Implementation

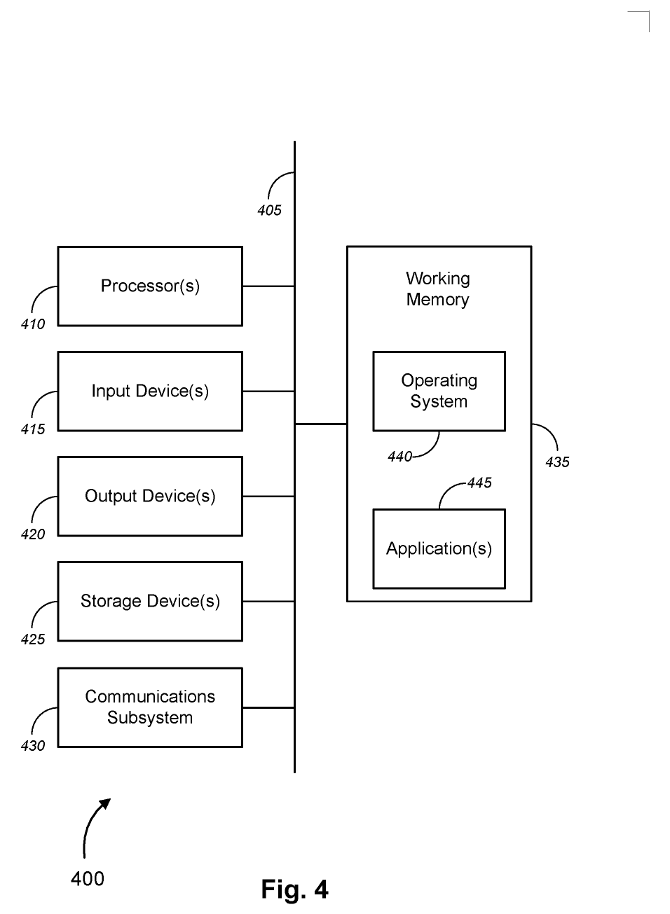

FIG. 4 is a block diagram illustrating an exemplary computer or system hardware architecture, in accordance with various embodiments. FIG. 4 provides a schematic illustration of one embodiment of a computer system 400 of the service provider system hardware that can perform the methods provided by various other embodiments, as described herein, and/or can perform the functions of computer or hardware system (i.e., user device 102, computing system 104a or 104b, AI system(s) 110a or 110b, and recipient devices 144a-144z, etc.), as described above. It should be noted that FIG. 4 is meant only to provide a generalized illustration of various components, of which one or more (or none) of each may be utilized as appropriate. FIG. 4, therefore, broadly illustrates how individual system elements may be implemented in a relatively separated or relatively more integrated manner.

The computer or hardware system 400 – which might represent an embodiment of the computer or hardware system (i.e., user device 102, computing system 104a or 104b, AI system(s) 110a or 110b, and recipient devices 144a-144z, etc.), described above with respect to FIGS. 1-3 – is shown including hardware elements that can be electrically coupled via a bus 405 (or may otherwise be in communication, as appropriate). The hardware elements may include one or more processors 410, including, without limitation, one or more general-purpose processors and/or one or more special-purpose processors (such as microprocessors, digital signal processing chips, graphics acceleration processors, and/or the like); one or more input devices 415, which can include, without limitation, a mouse, a keyboard, and/or the like; and one or more output devices 420, which can include, without limitation, a display device, a printer, and/or the like.

The computer or hardware system 400 may further include (and/or be in communication with) one or more storage devices 425, which can include, without limitation, local and/or network accessible storage, and/or can include, without limitation, a disk drive, a drive array, an optical storage device, solid-state storage device such as a random access memory ("RAM") and/or a read-only memory ("ROM"), which can be programmable, flash-updateable, and/or the like. Such storage devices may be configured to implement any appropriate data stores, including, without limitation, various file systems, database structures, and/or the like.

The computer or hardware system 400 might also include a communications subsystem 430, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network ("WWAN") device, cellular communication facilities, etc.), and/or the like. The communications subsystem 430 may permit data to be exchanged with a network (such as the network described below, to name one example), with other computer or hardware systems, and/or with any other devices described herein. In many embodiments, the computer or hardware system 400 will further include a working memory 435, which can include a RAM or ROM device, as described above.

The computer or hardware system 400 also may include software elements, shown as being currently located within the working memory 435, including an operating system 440, device drivers, executable libraries, and/or other code, such as one or more application programs 445, which may include computer programs provided by various embodiments (including, without limitation, hypervisors, virtual machines ("VMs"), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 400 and/or might take the form of source and/or installable code, which, upon compilation and/or installation on the computer or hardware system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 400) to perform methods in accordance with various embodiments of the invention. According to a set of embodiments, some or all of the procedures of such methods are performed by the computer or hardware system 400 in response to processor 410 executing one or more sequences of one or more instructions (which might be incorporated into the operating system 440 and/or other code, such as an application program 445) contained in the working memory 435. Such instructions may be read into the working memory 435 from another computer readable medium, such as one or more of the storage device(s) 425. Merely by way of example, execution of the sequences of instructions contained in the working memory 435 might cause the processor(s) 410 to perform one or more procedures of the methods described herein.

The terms "machine readable medium" and "computer readable medium," as used herein, refer to any medium that participates in providing data that causes a machine to operate in a specific fashion. In an embodiment implemented using the computer or hardware system 400, various computer readable media might be involved in providing instructions/code to processor(s) 410 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 425. Volatile media includes, without limitation, dynamic memory, such as the working memory 435. In some alternative embodiments, a computer readable medium may take the form of transmission media, which includes, without limitation, coaxial cables, copper wire, and fiber optics, including the wires that include the bus 405, as well as the various components of the communication subsystem 430 (and/or the media by which the communications subsystem 430 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 400. These signals, which might be in the form of electromagnetic signals, acoustic signals, optical signals, and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a storage device 425 either before or after execution by the processor(s) 410.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system, a first image of a first area;
autonomously identifying, by the computing system, a first object from the first area in the first image, using image recognition;
autonomously querying, by the computing system, at least one of one or more databases or one or more search engines for one or more objects that are equivalent to the first object and corresponding prices;
receiving, by the computing system, a set of results from the at least one of the one or more databases or the one or more search engines, the set of results including at least one equivalent object and at least one price associated with each equivalent object;
autonomously performing, by the computing system, a valuation of the first object, based on the at least one price associated with each of the at least one equivalent object that is included in the set of results;
autonomously generating, by the computing system, a report based on the valuation; and
presenting, by the computing system, the report to a user.

2. The method of claim 1, wherein the computing system is part of a user device, wherein the user device includes a camera and a local data storage device on which is stored images captured by the camera, wherein the first image is received from one of the camera or the local data storage device.

3. The method of claim 1, wherein the computing system includes one of a server computer, a cloud computing system, or a distributed computing system, wherein the first image is received from a user device via a network.

4. The method of claim 1, wherein autonomously identifying the first object from the first image comprises using an artificial intelligence ("AI") model that receives the first image as input and outputs the first object, wherein the AI model is one of local to the computing system or within an external computing system.

5. The method of claim 1, wherein the first area includes one of a room, an office, a suite, a hall, a shop, a vehicle, a garage, a storage facility, a warehouse, a museum, a marketplace, or an auction house, wherein the first object includes one of an article of furniture, a flooring finish, a lighting fixture, a plumbing fixture, a window, a door, a consumer electronic device, an optical data storage device, optical data storage media, a magnetic data storage device, magnetic data storage media, a phonograph, a phonograph record, an office appliance, a kitchen appliance, a kitchen tool, a utensil, dishes, cookware, dinnerware, pottery, a book, a poster, a painting, a drawing, a sculpture, a statue, an ornament, sports equipment, workout equipment, clothing, footwear, jewelry, a timepiece, a fashion accessory, a piece of luggage, bedding, a firearm, a blade, a tool, a vehicle, a vehicle feature, or a vehicle accessory.

6. The method of claim 1, wherein autonomously identifying the first object from the first image comprises categorizing, by the computing system, the first object into a first item category of a plurality of item categories, wherein the plurality of item categories includes two or more of furniture, flooring, lighting fixtures, plumbing fixtures, building parts, electronic device, media content storage device, media content media, office appliances, kitchenware, books, art pieces, sporting equipment, workout equipment, fashion, fashion accessories, bedding, tools, vehicles, or vehicle components and accessories, wherein autonomously querying the at least one of the one or more databases or the one or more search engines is based on the identified first object and the first item category.

7. The method of claim 1, wherein autonomously querying the at least one of the one or more databases or the one or more search engines comprises:
generating and sending, by the computing system, a prompt to a language model ("LM") to generate one or more queries;
receiving, by the computing system, the one or more queries from the LM; and
sending, by the computing system, each of the one or more queries to a corresponding one of the at least one of the one or more databases or the one or more search engines.

8. The method of claim 1, wherein autonomously performing the valuation of the first object comprises determining, by the computing system, the valuation of the first object, based on algorithmic analysis and compilation of the at least one price associated with each of the at least one equivalent object that is included in the set of results, and based on how current each of the at least one price is.

9. The method of claim 1, wherein the report includes one of a spreadsheet, a summary document, an appraisal report, an insurance assessment report, a sales catalogue, an auction catalogue, an estate valuation report, or an inventory.

10. The method of claim 1, wherein presenting the report comprises presenting, by the computing system, the report in at least one of a user interface ("UI"), a software application ("app"), a web portal, or an email message.

11. The method of claim 1, further comprising:
providing, by the computing system, options to input a payment receipt of the first object via one of a UI, an app, a web portal, a camera of a user device, a local data storage device of the user device, or an email message;
receiving, by the computing system, an image of the payment receipt of the first object via one of the UI, the app, the web portal, the camera of the user device, the local data storage device of the user device, or the email message;
extracting, by the computing system, pricing information for the first object from the image of the payment receipt of the first object;
autonomously updating, by the computing system, the valuation of the first object to generate an updated valuation of the first object, based on the extracted pricing information for the first object; and
autonomously generating, by the computing system, an updated report based on the updated valuation; and
presenting, by the computing system, the updated report to the user.

12. The method of claim 1, further comprising:
providing, by the computing system and via one of a UI, an app, or a web portal, options to enter at least one of updated information, corrected information, notes, or comments associated with at least one of the first object, the valuation for the first object, or additional information that is relevant to valuation of the first object;
receiving, by the computing system, the at least one of the updated information, the corrected information, the notes, or the comments;
autonomously generating, by the computing system, an annotated report based on the at least one of the updated information, the corrected information, the notes, or the comments; and
presenting, by the computing system, the annotated report to the user.

13. The method of claim 12,
wherein the options to enter the at least one of the updated information, the corrected information, the notes, or the comments include options to enter the at least one of the updated information, the corrected information, the notes, or the comments using voice input via a microphone;
wherein receiving the at least one of the updated information, the corrected information, the notes, or the comments includes:
receiving, by the computing system, a first voice input associated with the at least one of the updated information, the corrected information, the notes, or the comments; and
converting, by the computing system, the first voice input into a first textual input, using speech-to-text functionality; and
wherein the annotated report is autonomously generated based on at least the first textual input converted from the first voice input.

14. The method of claim 1, wherein the one of the first image or the first video depicts the first object and a plurality of other objects, wherein the method further comprises:
providing, by the computing system and on the display device, options to select a second object among the plurality of other objects, wherein the options to select the second object include options to manually draw a boundary around the second object using one of a finger input or a stylus input, options to draw boundary shapes around the second object, or options to highlight the second object after being autonomously identified by the computing system;
receiving, by the computing system, selection of the second object and selection of options to categorize and to perform an ecommerce search of the second object;
categorizing, by the computing system, the second object into one or more other item categories among the plurality of item categories;
autonomously querying, by the computing system, the at least one of the one or more databases or the one or more search engines for a plurality of equivalent other objects that are equivalent to the second object and corresponding descriptions of the second object, further based on the one or more other item categories;
autonomously generating, by the computing system and using an AI model, AI-generated descriptions of the second object;
autonomously querying, by the computing system, one or more ecommerce platforms for the second object based on at least one of the one or more other item categories or the AI-generated descriptions of the second object;
receiving, by the computing system, a second set of results from the one or more ecommerce platforms, the second set of results including at least one of the second object or one or more third objects equivalent to the second object;
presenting, by the computing system, the second set of results to the user.

15. A method, comprising:
capturing, by a computing system and using a camera, one of a first image or a first video of a first area;
autonomously identifying, by the computing system, a first object from the first area in the one of the first image or the first video, using image recognition;
autonomously querying, by the computing system, at least one of one or more databases or one or more search engines for one or more objects that are equivalent to the first object and corresponding prices;
receiving, by the computing system, a set of results from the at least one of the one or more databases or the one or more search engines, the set of results including at least one equivalent object and at least one price associated with each equivalent object;
autonomously performing, by the computing system, a valuation of the first object, based on the at least one price associated with each of the at least one equivalent object that is included in the set of results;
autonomously generating, by the computing system, a valuation output based on the valuation; and
presenting, by the computing system, the valuation output on a display device.

16. The method of claim 15, further comprising:
categorizing, by the computing system, the first object into a first item category of a plurality of item categories, wherein the plurality of item categories includes two or more of furniture, flooring, lighting fixtures, plumbing fixtures, building parts, electronic device, media content storage device, media content media, office appliances, kitchenware, books, art pieces, sporting equipment, workout equipment, fashion, fashion accessories, bedding, tools, vehicles, or vehicle components and accessories;
wherein autonomously querying the at least one of the one or more databases or the one or more search engines is based on the identified first object and the first item category.

17. The method of claim 16, wherein the one of the first image or the first video depicts the first object and a plurality of other objects, wherein the method further comprises:
providing, by the computing system and on the display device, options to select one or more other objects among the plurality of other objects, wherein the options to select the one or more other objects include options to manually draw a boundary around the one or more other objects using one of a finger input or a stylus input, options to draw boundary shapes around the one or more other objects, or options to highlight the one or more other objects after being autonomously identified by the computing system;
receiving, by the computing system, selection of the one or more other objects and selection of options to categorize and perform valuation of the selected one or more other objects;
categorizing, by the computing system, the one or more other objects into one or more other item categories among the plurality of item categories;
autonomously querying, by the computing system, the at least one of the one or more databases or the one or more search engines for a plurality of equivalent other objects that are equivalent to the one or more other objects and a corresponding plurality of other prices, further based on the one or more other item categories;
receiving, by the computing system, a second set of results from the at least one of the one or more databases or the one or more search engines, the second set of results including, for each of the one or more other objects, at least one equivalent other object and at least one other price associated with each equivalent other object;
autonomously performing, by the computing system, a valuation of each of the one or more other objects, based on the at least one other price associated with each equivalent other object that is included in the second set of results;
autonomously generating, by the computing system, a second valuation output based on the valuation of each of the one or more other objects; and
presenting, by the computing system, the second valuation output on the display device.

18. The method of claim 15, wherein the camera is part of a user device, wherein the method further comprises:
providing, by the computing system and on the display device, options to input a payment receipt of the first object via one of a UI, an app, a web portal, the camera of the user device, a local data storage device of the user device, or an email message;
receiving, by the computing system, an image of the payment receipt of the first object via one of the UI, the app, the web portal, the camera of the user device, the local data storage device of the user device, or the email message;
extracting, by the computing system, pricing information for the first object from the image of the payment receipt of the first object;
autonomously updating, by the computing system, the valuation of the first object to generate an updated valuation of the first object, based on the extracted pricing information for the first object; and
autonomously generating, by the computing system, an updated valuation output based on the updated valuation; and
presenting, by the computing system, the updated valuation output on the display device.

19. The method of claim 15, further comprising:
providing, by the computing system and on the display device via one of a UI, an app, or a web portal, options to enter at least one of updated information, corrected information, notes, or comments associated with at least one of the first object, the valuation for the first object, or additional information that is relevant to valuation of the first object;
receiving, by the computing system, the at least one of the updated information, the corrected information, the notes, or the comments;
autonomously generating, by the computing system, an annotated valuation output based on the at least one of the updated information, the corrected information, the notes, or the comments; and
presenting, by the computing system, the annotated valuation output on the display device.

20. A method, comprising:
capturing, by a computing system and using a camera, one of a first image or a first video of a first area;
autonomously identifying, by the computing system, a first object from the first area in the one of the first image or the first video, using image recognition;
autonomously querying, by the computing system, at least one of one or more databases or one or more search engines for one or more objects that are equivalent to the first object and corresponding prices;
receiving, by the computing system, a set of results from the at least one of the one or more databases or the one or more search engines, the set of results including at least one equivalent object and at least one price associated with each equivalent object;
autonomously performing, by the computing system, a valuation of the first object, based on the at least one price associated with each of the at least one equivalent object that is included in the set of results;
autonomously generating, by the computing system, a valuation output based on the valuation; and
presenting, by the computing system, the valuation output on a display device.
